(19) United States
(12) Patent Application Publication
(10) Pub. No.: US 2006/0022458 A1
(43) Pub. Date: Feb. 2, 2006

(54) Sealed fluid connector assembly

(76) Inventors: Timothy Droste, Howell, MI (US); Thomas Skill, St. Clair Shores, MI (US); Eugene Mazurek, Williams Bay, WI (US); Thomas Cutsinger, Redford, MI (US); Bruce Murden, South Iyon, MI (US)

Correspondence Address: MACMILLAN, SOBANSKI & TODD, LLC, ONE MARITIME PLAZA - FOURTH FLOOR, 720 WATER STREET, TOLEDO, OH, 43604, US

(21) Appl. No.: 10/899,968

(22) Filed: Jul. 27, 2004

(51) Int. Cl. F16L 41/00

(52) U.S. Cl. 285/206

(57) ABSTRACT

A fluid connector assembly is sealingly received by a housing having a bore. A hollow tube has a first end that is received in the housing bore, and a seal retention lip that is spaced from the first end and extends radially outward from the outer surface of the tube. A ring shaped band seal is sealingly mounted about the outer surface of the hollow tube between the first end and the seal retention lip and an outer seal surface sealingly engages the bore in the housing. Preferably, the band seal is formed from an elastomeric type of material. A seal backer ring is mounted about the outer surface of the hollow tube between and in engagement with the band seal and a first side of the seal retention lip, with the seal backer ring including an outer surface that is in surface contact with the bore of the housing in order to absorb clamping loads. The fluid connector assembly also includes a retainer plate mounted about the hollow tube and engaging with a second opposite side of the seal retention lip, and with the retainer plate being clamped to the outer surface of the housing.

### BACKGROUND OF INVENTION

The present invention relates to hydraulic connectors with seals.

Transmission cooler tubes that transport hydraulic oil between the vehicle transmission and oil cooler may be made of metal or have metal connectors at the ends. For such conventional tubes, the endform that connects to the port of the transmission housing is machined in order to allow for a seal assembly to be employed. However, the machining is relatively expensive and may be more prone to leakage than is desired. In particular, an assembly process includes mounting an O-ring to the machined endform. However, machined parts tend to have burrs due to the machining process. For the endform, then, any burrs that are not removed prior to assembly may potentially cut the O-ring, thus increasing the risk of leakage at this connector. Typically, then, a second O-ring recess is machined into the endform and a second O-ring is employed in order to assure a good seal. However, this configuration makes the machining and seal assembly even more complex and costly.

Thus, it is desirable to have a connector assembly that will connect a stiff tube to a housing that seals well and that overcomes the drawbacks of the prior art.

### SUMMARY OF INVENTION

In its embodiments, the present invention contemplates a fluid connector assembly adapted to be sealingly received by a housing, with the housing including a bore having a portion with a predetermined bore diameter extending inwardly from an outer surface. The fluid connector assembly includes a hollow tube, being made of metal, and having an outer surface defining an outer diameter, a first end, and a seal retention lip spaced from the first end; and a ring shaped band seal, having an inner seal surface and an outer seal surface, and being sealingly mounted about the outer surface of the hollow tube between the first end and the seal retention lip, with the outer seal surface sized to sealingly engage the bore when the fluid connector assembly is received by the housing, and with the band seal being made of a material with a predetermined hardness. The fluid connector assembly also preferably includes a seal backer ring, including a central bore mounted about the outer surface of the hollow tube, and being located between and in engagement with the band seal and a first side of the seal retention lip, with the seal backer ring including an outer surface having a portion that has a diameter greater than the diameter of the predetermined bore diameter of the housing, and with the seal backer ring being made of a material having a hardness that is greater than the predetermined hardness of the band seal; and a retainer plate having a central hole mounted about the hollow tube and being in engagement with a second opposite side of the seal retention lip, and with the retainer plate being adapted to be clampable to the outer surface of the housing.

The present invention further contemplates a sealed fluid connection having a housing, with the housing including a bore having a first portion with a predetermined bore diameter extending inwardly from an outer surface. The sealed fluid connection also includes a fluid connector assembly including a hollow tube, being made of a material with a predetermined hardness, and having an outer surface defining an outer diameter, a first end extending into the bore, and a seal retention lip spaced from the first end and extending radially outward from the outer diameter; a ring shaped band seal, having an inner seal surface and an outer seal surface, and being sealingly mounted about the outer surface of the hollow tube between the first end and the seal retention lip, with the outer seal surface sealingly engaging the first portion of the bore, and with the band seal being made of a material with a predetermined hardness; a seal backer ring, including a central bore mounted about the outer surface of the hollow tube, and being located between and in engagement with the band seal and a first side of the seal retention lip, with the seal backer ring including an outer surface having a portion that is in surface contact with the first portion of the bore, and with the seal backer ring being made of a material having a hardness that is greater than the predetermined hardness of the band seal and less than the predetermined hardness of the hollow tube; and a retainer plate having a central hole mounted about the hollow tube and being in engagement with a second opposite side of the seal retention lip, and with the retainer plate being clamped to the outer surface of the housing.

An advantage of an embodiment of the present invention is that a stiff tube to housing fluid connection is made that assures a good seal while being relatively low cost to fabricate and assemble.

### BRIEF DESCRIPTION OF DRAWINGS

FIG. 1 is a perspective, partial sectioned view of a hydraulic connector assembly and a portion of a vehicle transmission in accordance with the present invention.

FIG. 2 is a sectional view of the hydraulic connector assembly mounted to a vehicle transmission, taken along line 2-2 in FIG. 1 and rotated about thirty degrees clockwise.

### DETAILED DESCRIPTION

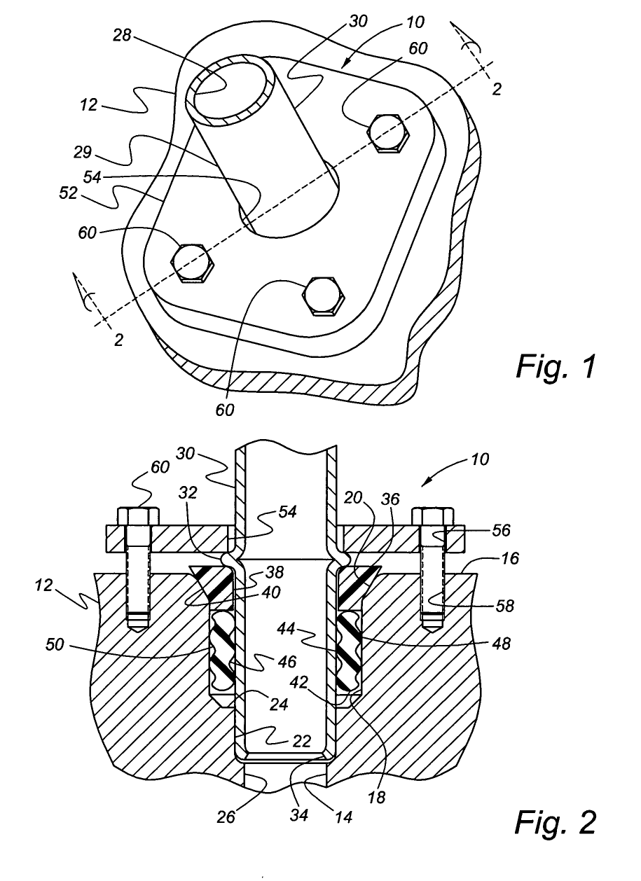

FIGS. 1 and 2 illustrate a hydraulic connector assembly 10 shown mounted to a transmission housing 12 of a vehicle transmission. While a transmission housing 12 is shown as an example, this seal assembly applies to other types of housings where a stiff tube connects thereto and requires a good fluid seal therebetween.

The transmission housing 12 includes a port, in the form of a bore 14, extending inwardly from an outer surface 16 of the transmission housing 12 to a conventional inner fluid cavity (not shown). The bore 14 includes three regions having different diameters and features. The first region 18 of the bore 14 has the largest diameter and is exposed to the outer surface 16 of the transmission housing 12. Preferably, the first region 18 includes a chamfered portion 20 where the bore 14 meets the outer surface 16. This chamfered portion 20 will help guide the connector assembly 10 into the bore 14 during the assembly process and also provide support for the connector assembly 10, as discussed below.

The bore 14 includes a second region 22 that is adjacent to and has a diameter that is smaller than the diameter of the first region 18. The intersection 24 between the first region 18 and the second region 22 forms a stop wall that sets a maximum limit for how far a seal (discussed below) can slide into the bore 14. The bore also includes a third region 26 that is adjacent to and has a smaller diameter than the second region 22. The diameter of the third region 26 is preferably the appropriate size for the amount of hydraulic flow through this assembly.

The hydraulic connector assembly 10 includes a hollow, generally cylindrical tube 30 that is preferably made of steel with a corrosion coating. Although, if so desired, metals other than steel may be employed. This tube 30 is preferably formed as an extrusion, which is less expensive than forming a machined part. The tube 30 includes an inner surface 28 that defines an inner diameter with the inside diameter of the tube 30 being about equal to the diameter of the third region 26, since this is the desired size needed for the amount of hydraulic fluid flow therethrough.

A seal retention lip 32 is formed in the tube 30, spaced from a tube end 34 a predetermined distance such that, after assembly, the seal retention lip 32 will preferably remain just above the outer surface 16. Preferably, the seal retention lip 32 is formed integral with the tube 30, with integral meaning that the seal retention lip is actually part of the wall of the tube 30 that is bent outward to form this feature. During the forming process that creates the seal retention lip 32, the tube end 34 tends to be bent radially inward. It is preferable to leave this slight inward curvature at the tube end 34 because this helps with the assembly of components (discussed below) onto an outer surface 29 of the tube 30 without damaging the components. The outer surface 29 of the tube 30 near the tube end 34 preferably has an outer diameter that is just slightly smaller than the diameter of the second region 22 of the bore. In this way, the second region 22 will help guide the tube 30 during the assembly process and help assure the proper orientation of the tube 30 relative to the transmission housing 12.

A generally cylindrical seal backer ring 36 includes a central bore 38 that has a diameter that is slightly larger than the outer diameter of the tube 30, but small enough that the seal retention lip extends beyond this diameter. The seal backer ring 36 slides over the tube end 34 and is slid against the seal retention lip 32. An outer surface 40 of the seal backer ring 36 is generally conical in shape. It has a narrower portion, which is nearer to the tube end 34 and has a smaller diameter than the first region 18 of the bore 14, and a wider portion, which abuts the seal retention lip 32 and is wider than the first region 18. Preferably, the middle portion, which tapers from the narrower portion to the wider portion, has a slope that matches that of the chamfer portion 20 of the first region 18. This creates a relatively large surface contact therebetween for absorbing clamping loads (discussed below), absorbing side loading, and minimizing the risk of the connector assembly 10 tipping relative to the housing 12. The seal backer ring 36 is preferably made of a relatively hard material, such as a hard plastic. For example, the seal backer ring 36 may be made of a thermoplastic polyamide type of material, such as nylon 6. Although, the material of the seal backer ring 36 is preferably softer than the materials employed for the housing 12 and tube 30.

A band seal 42 is preferably ring shaped, with a set of inner sealing beads 44 that project radially inward and extend circumferentially about an inner surface 46, and a set of outer sealing beads 48 that project radially outward and extend circumferentially about an outer surface 50. The band seal 42 is preferably sized so that the diameter of the inner surface 46 is slightly larger than the diameter of the outer surface 29 of the tube 30 and the diameter of the inner sealing beads 44 is slightly smaller than the diameter of the outer surface 29 of the tube 30. In this way, the band seal 42 can be slid onto the tube 30, but with an interference fit between the inner sealing beads 44 and the outer surface 29 of the tube 30. The inner sealing beads 44 will then create locations of high sealing force extending circumferentially around the tube 30. While the band seal 42 is shown with three inner sealing beads 44, other numbers of beads may be employed, as is desired for the particular application.

The band seal 42 is also preferably sized so that the diameter of the outer surface 50 is slightly smaller than the diameter of the first region 18 of the bore 14 and the diameter of the outer sealing beads 48 is slightly larger than the diameter of the first region 18. Again, an interference fit situation is created where the band seal 42 can be slid into the bore 14, but with an interference fit between the outer sealing beads 48 and the surface of the first region 18 of the bore 14 in order to create a seal. While the band seal 42 is shown with two outer sealing beads 48, other numbers of beads may be employed, as desired.

The band seal 42 is preferably made of a relatively soft material with good sealing properties, such as a fluoroelastomer. Such a material may be, for example, VITON, a material produced by DuPont-Dow Elastomers of Wilmington, Del. Although, if so desired, other suitable elastomeric materials may be employed instead. Whatever the material, it is preferably softer than the material of the seal backer ring 36.

The hydraulic connector assembly 10 also includes a retainer plate 52. The retainer plate 52 is preferably made of a stiff material, such as a metal. The retainer plate 52 has a central hole 54 with a diameter that is slightly larger than the outer diameter of the tube 30, but small enough that the seal retention lip extends beyond its diameter. The retainer plate 52 can be slid on the tube 30 over the tube end 34 and past the location where the seal retention lip 32 will be formed, prior to forming the retention lip 32, or, if the particular tube shape allows, slid on from the opposite end of the tube, either before or after the retention lip 32 is formed. The retainer plate 52 also includes fastener holes 56 spaced about the plate 52 near its periphery. While the retainer plate 52 is illustrated with four fastener holes 56, other numbers of fastener holes 56 may be employed if so desired.

The transmission housing 12 includes a matching set of fastener holes 58 that align with the fastener holes 56 in the retainer plate 52. Each fastener hole 58 in the transmission housing is preferably a threaded hole. A fastener 60 extends through each fastener hole 56 in the retainer plate 52 and is threaded into the corresponding hole 58 in the housing 12. Even though threaded fasteners 60 are disclosed for clamping the retainer plate 52 to the housing 12, other conventional means for clamping the plate 52 to the housing 12 may be employed if so desired.

The forming and assembly process for the hydraulic connector assembly 10 will now be described. As discussed above, the retainer plate 52 is slid onto the tube end 34 and past the location of the seal retention lip 32 prior to forming the seal retention lip 32 if it cannot be slid on from the other end of the tube 30. A conventional forming process is performed on the tube 30 to create the seal retention lip 32, which may also cause an inward curvature on the tube end 34 during this process. The seal backer ring 36 is slid over the tube end 34 and up against the retention lip 32. The band seal 42 is then press fit over the tube end 34 and is slid up against the seal backer ring 36.

The tube end 34 is aligned with the bore 14, with the tube 30 oriented generally parallel to the bore 14. The retainer plate 52 and tube 30 are pressed toward the outer surface 16 of the housing 12, causing the band seal 42 and seal backer ring 36 to slide into the first region 18 of the bore 14, until the outer surface 40 of the seal backer ring 36 abuts the chamfered portion 20 of the first region 18. The seal backer ring 36 abutting the chamfered portion 20 will help to stabilize and center the connector assembly 10. The fasteners 60 are slid through the fastener holes 56 in the retainer plate 52 and threaded into the fastener holes 58 in the housing 12. The fasteners 60 are tightened until the desired clamp load is reached. As an alternative, when the tube end is aligned with the bore 14, the fasteners 60 may be threaded into the fastener holes 58 in the housing 12 and tightened, thus forcing the band seal 42 and seal backer ring 36 into the bore 14.

Since the seal backer ring 36 is a relatively stiff material, it will limit how far the band seal 42 is pressed into the bore 14 and will also absorb the clamp loads. Thus, the band seal 42 will be subjected to only its radial sealing loads on its inner sealing beads 44 and outer sealing beads 48, without being subject to axial deformation due to clamping loads. Accordingly, preferably, the first region 18 is long enough to accommodate the band seal 42 and seal backer ring 36 without the band seal being pressed against the intersection 24 between the first region 18 and second region 22 of the bore 14.

As an alternative, the tube 30 may be made of a relatively hard material, such as a hard plastic, instead of metal. The seal retention lip 32, then, may be integrally molded with the tube 30. For this alternative, it is still preferable that the material of the seal backer ring 36 is softer than the material of the housing 12 and the tube 30, yet harder than the material of the band seal 42.

While certain embodiments of the present invention have been described in detail, those familiar with the art to which this invention relates will recognize various alternative designs and embodiments for practicing the invention as defined by the following claims.

1. A fluid connector assembly adapted to be sealingly received by a housing, with the housing including a bore having a portion with a predetermined bore diameter extending inwardly from an outer surface and a chamfer portion formed in the bore adjacent the outer surface of the housing, the fluid connector assembly comprising:
a hollow tube, being made of metal, and having an outer surface defining an outer diameter, a first end, and a seal retention lip spaced from the first end and extending radially outward from the outer diameter;
a ring shaped band seal, having an inner seal surface and an outer seal surface, and being sealingly mounted about the outer surface of the hollow tube between the first end and the seal retention lip, with the outer seal surface sized to sealingly engage the bore when the fluid connector assembly is received by the housing, and with the band seal being made of a material with a predetermined hardness;
a seal backer ring, including a central bore mounted about the outer surface of the hollow tube, and being located between and secured in engagement with the band seal and a first side of the seal retention lip, with the seal backer ring including a conical outer surface having a diameter greater than the diameter of the predetermined bore diameter of the housing and being in contact engagement with the chamfer portion, and with the seal backer ring being made of a material having a hardness that is greater than the predetermined hardness of the band seal; and
a retainer plate having a central hole mounted about the hollow tube and being in engagement with a second opposite side of the seal retention lip, and with the retainer plate being adapted to be secured to the outer surface of the housing and spaced from the outer surface of the housing by the seal retention lip.

2. (canceled)

3. The fluid connector assembly of claim 1 wherein the inner seal surface of the band seal includes at least one inner sealing bead extending radially inward therefrom.

4. The fluid connector assembly of claim 1 wherein the outer seal surface of the band seal includes at least one outer sealing bead extending radially outward therefrom.

5. The fluid connector assembly of claim 1 wherein the first end of the hollow tube curves radially inward.

6. The fluid connector assembly of claim 1 wherein the retainer plate includes at least one fastener hole and at least one fastener adapted to be threadably engaged with a corresponding at least one fastener hole in the housing.

7. The fluid connector assembly of claim 1 wherein the hollow tube is formed by extruded steel.

8. The fluid connector assembly of claim 1 wherein the seal backer ring is made of a thermoplastic polyamide and the band seal is made of an elastomeric material.

9. The fluid connector assembly of claim 1 wherein the hollow tube is an extrusion and the seal retention lip is formed integrally with the hollow tube.

10. A sealed fluid connection comprising:
a housing including a bore having a first portion with a predetermined bore diameter extending inwardly from an outer surface, and a chamfer portion formed in the bore adjacent the outer surface of the housing; and
fluid connector assembly including a hollow tube, being made of a material with a predetermined hardness, and having an outer surface defining an outer diameter, a first end extending into the bore, and a seal retention lip spaced from the first end and extending radially outward from the outer diameter; a ring shaped band seal, having an inner seal surface and an outer seal surface, and being sealingly mounted about the outer surface of the hollow tube between the first end and the seal retention lip, with the outer seal surface sealingly engaging the first portion of the bore, and with the band seal being made of a material with a predetermined hardness; a seal backer ring including a central bore mounted about the outer surface of the hollow tube, and being located between and secured in engagement with the band seal and a first side of the seal retention lip, with the seal backer ring including a conical outer surface having a portion that is in surface contact with the chamfer portion of the bore, and with the seal backer ring being made of a material having a hardness that is greater than the predetermined hardness-of the band seal and less than the predetermined hardness of the hollow tube; and a retainer plate having a central hole mounted about the hollow tube and being in engagement with a second opposite side of the seal retention lip, and with the retainer plate being secured to the housing and spaced from the outer surface of the housing by the seal retention lip and the seal backer ring.

11. The sealed fluid connection of claim 10 wherein the bore of the housing includes a second portion, spaced farther from the outer surface than the first portion, with the second portion having a diameter that is about the same diameter as the outer diameter of the outer surface of the hollow tube, and with the first end of the tube extending within the second portion.

12. The sealed fluid connection of claim 10 wherein the housing is a transmission housing and the fluid connector assembly is adapted for transmitting hydraulic oil therethrough.

13. The sealed fluid connection of claim 10 wherein the hollow tube is made of extruded metal and the seal retention lip is formed integrally with the hollow tube.

14. The sealed fluid connection of claim 10 wherein the retainer plate includes at least one fastener hole and the housing includes at least one corresponding threaded fastener hole, and the fluid connector assembly includes at least one fastener extending through the at least one fastener hole in the retainer plate and being threadably engaged with the at least one fastener hole in the housing.

15. (canceled)

16. The sealed fluid connection of claim 10 wherein the inner seal surface of the band seal includes at least one inner sealing bead extending radially inward therefrom.

17. The sealed fluid connection of claim 10 wherein the outer seal surface of the band seal includes at least one outer sealing bead extending radially outward therefrom.

18. The sealed fluid connection of claim 10 wherein the hollow tube is made of a plastic material, with the seal retention lip being molded integrally with the hollow tube.

19. The sealed fluid connection of claim 10 wherein the seal backer ring is made of a thermoplastic polyamide and the band seal is made of an elastomeric material.

20. A fluid connector assembly adapted to be sealingly received by a housing, with the housing including a bore having a portion with a predetermined bore diameter extending inwardly from an outer surface, and a chamfer portion formed in the bore adjacent the outer surface of the housing, the fluid connector assembly comprising:
a hollow tube, being made of extruded metal, and having an outer surface defining an outer diameter, a first end, and a seal retention lip spaced from the first end and extending radially outward from the outer diameter, with the seal retention lip being formed integrally with the hollow tube;
a ring shaped band seal, having an inner seal surface and an outer seal surface, and being sealingly mounted about the outer surface of the hollow tube between the first end and the seal retention lip, with the outer seal surface sized to sealingly engage the bore when the fluid connector assembly is received by the housing, and with the band seal being made of a material with a predetermined stiffness;
a seal backer ring, including a central bore mounted about the outer surface of the hollow tube, and being located between and secured in engagement with the band seal and a first side of the seal retention lip, with the seal backer ring including a conical outer surface having a diameter greater than the diameter of the predetermined bore diameter of the housing, and being in contact engagement with the chamfer portion, and with the seal backer ring being made of a material having a stiffness that is greater than the predetermined stiffness of the band seal; and
a retainer plate having a central hole mounted about the hollow tube and being in engagement with a second opposite side of the seal retention lip, and with the retainer plate being adapted to be secured to the outer surface of the housing, and spaced from the outer surface of the housing by the seal retention lip and the seal backer ring.
